(19) United States
(12) Patent Application Publication
(10) Pub. No.: US 2024/0398046 A1
(43) Pub. Date: Dec. 5, 2024

(54) Garment Electronic Display System

(71) Applicants: Ali Jackson, JR., White Oak, PA (US); Heather Jackson, White Oak, PA (US)

(72) Inventors: Ali Jackson, JR., White Oak, PA (US); Heather Jackson, White Oak, PA (US)

(21) Appl. No.: 18/524,029

(22) Filed: Nov. 30, 2023

Related U.S. Application Data
(60) Provisional application No. 63/505,199, filed on May 31, 2023.

(51) Int. Cl. A41D 1/00

(52) U.S. Cl. CPC A41D 1/002; A41D 2300/30

(57) ABSTRACT

A garment electronic display system is provided. The device is comprised of a garment with at least one display screen attached to the garment. The display screen can display a specific picture, video, word, letter, phrase, advertisement, etc., based on an in-game condition of a sporting event, wherein the picture, video, word, letter, phrase, advertisement, etc., may relate to said condition. Further, users can use a software of the system to upload their own content to be displayed on the screen and can further configure said content to be displayed in response to certain conditions of the sporting event.

### CROSS-REFERENCE TO RELATED APPLICATION

The present application claims priority to, and the benefit of, U.S. Provisional Application No. 63/505,199, which was filed on May 31, 2023, and is incorporated herein by reference in its entirety.

### FIELD OF THE INVENTION

The present invention relates generally to the field of advertising garments. More specifically, the present invention relates to a garment electronic display system comprised of a garment with at least one electronic display screen attached to the garment. The display screen may play a piece of content in response to a condition present at a live sporting event. Accordingly, the present disclosure makes specific reference thereto. Nonetheless, it is to be appreciated that aspects of the present invention are also equally applicable to other like applications, devices, and methods of manufacture.

### BACKGROUND

Businesses and individuals alike often seek creative and innovative methods to draw consumer attention to their products and services. The competitive nature of a marketplace necessitates distinctive strategies for advertisements to stand out. Further, sporting events have emerged as an ideal platform for such advertising as these events are characterized by high levels of engagement and emotional investment from the audience, offering businesses and individuals a prime opportunity to showcase their offerings. However, it's important to note that the impact of stadium advertising can be limited by the fact that not all fans are continuously present in their seats to observe ads within the stadium.

Therefore, there exists a long-felt need in the art for an improved advertising system. There also exists a long-felt need in the art for a garment electronic display system. Furthermore, there exists a long-felt need in the art for a garment electronic display system that can be used to advertise at a sporting event. More specifically, there exists a long-felt need in the art for a garment electronic display system that can be used to advertise at a sporting event wherein the system does not require a user to be in a stadium/arena or looking at a stadium/arena advertisement. In addition, there exists a long-felt need in the art for a garment electronic display system that can be used to advertise at a sporting event wherein the system does not require a user to be in a stadium/arena or looking at a stadium/arena advertisement while advertising in an innovative and creative manner.

The subject matter disclosed and claimed herein, in one embodiment thereof, comprises a garment electronic display system. The device is comprised of a garment with at least one display screen attached to the garment. The display screen can display a specific picture, video, word, letter, phrase, advertisement, etc., based on an in-game condition such as, but not limited to, a touchdown, a goal, a made basket, a scored point, a win, a loss, a tie, a play, a conversion, a homerun, a steal, a walk, a strikeout, an ejection, an official's call, etc., wherein the picture, video, word, letter, phrase, advertisement, etc., may relate to said condition. Further, users can use a software of the system to upload their own content to be displayed on the screen and can further configure said content to be displayed in response to certain conditions of the sporting event.

In this manner, the garment electronic display system of the present invention accomplishes all the foregoing objectives and provides an advertising system that can be used to advertise at a sporting event. Further, while doing so the system does not require a user to be in a stadium/arena or looking at a stadium/arena advertisement. Further, the system can be used to increase the experience of fans by providing interactive content shown on the display screen in relation to in-game events.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a garment electronic display system comprised of at least one garment with at least one display screen attached to the garment. The display screen can be controlled by a software/mobile application that allows custom advertisements, messages, etc., to be played on the screen.

The garment of the system may include, but is not limited to, a jersey, a shirt, a jacket, a coat, a pair of pants, a pair of shorts, a hat, a top, a bottom, a pair of shoes, etc. At least one display screen is fixedly or removably attached to the garment via at least one fastener. The display screen is preferably a flexible electronic display screen to allow the screen to bend/move as the garment moves to prevent cracking/damage of the screen.

The display screen is also comprised of at least one receiver which places the screen in wireless electrical communication with the software of the system. The software may be in the form of a computer software program, a mobile application, etc. The software allows a user to relay various pictures, videos, words, letters, phrases, advertisements, etc., to the screen such that they are displayed on the screen.

The software may also allow a user to select at least one condition that when present relays a specific picture, video, word, letter, phrase, advertisement, sound, etc., to the display screen such that it is played. The condition may include, but is not limited to, a touchdown, a goal, a made basket, a scored point, a win, a loss, a tic, a play, a conversion, a homerun, a steal, a walk, a strikeout, an ejection, an official's call, etc., wherein the picture, video, word, letter, phrase, advertisement, noise, etc., may relate to said condition. In this manner, the screen automatically displays specific content when a specific event occurs during a live sporting event.

The present invention is also comprised of a method of using the device. First, a device is provided comprised of a garment comprised of at least one display screen, wherein the display screen is in wireless electrical communication with a software. Then, a user can wear the garment. Then, a user can attach the screen to the garment via a fastener. Next, the user can attend a sporting event while wearing the garment. Then, a piece of content such as, but not limited to, pictures, videos, words, letters, phrases, advertisements, sounds, etc., is played on the display screen and/or a speaker of the screen, in response to a condition present at the sporting event. Said condition may include, but is not limited to, a touchdown, a goal, a made basket, a scored point, a win, a loss, a tic, a play, a conversion, a homerun, a steal, a walk, a strikeout, an ejection, an official's call, etc.

The present invention is also comprised of a second method of using the device. First, a device is provided comprised of a garment comprised of at least one display screen, wherein the display screen is in wireless electrical communication with a software. Then, a user can wear the garment. Next, the user can attend a sporting event while wearing the garment. Then, a piece of content such as, but not limited to, pictures, videos, words, letters, phrases, advertisements, sounds, etc., is played on the display screen and/or a speaker of the screen. Next, a user can program a second piece of content to play on the screen and/or speaker in sequence with the first piece of content.

Accordingly, the garment electronic display system of the present invention is particularly advantageous as it provides an advertising system that can be used to advertise at a sporting event. Further, while doing so the system does not require a user to be in a stadium/arena or looking at a stadium/arena advertisement. Further, the system can be used to increase the experience of fans by providing interactive content shown on the display screen in relation to in-game events. In this manner, the garment electronic display system overcomes the limitations of existing advertising methods and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a garment and a display screen of one potential embodiment of a garment electronic display system of the present invention in accordance with the disclosed architecture;

FIG. 2 illustrates a graphical view of a software of one potential embodiment of a garment electronic display system of the present invention in accordance with the disclosed architecture;

FIG. 3 illustrates a flowchart of a method of using one potential embodiment of a garment electronic display system of the present invention in accordance with the disclosed architecture; and

FIG. 4 illustrates a flowchart of a method of using one potential embodiment of a garment electronic display system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved advertising system. There also exists a long-felt need in the art for a garment electronic display system. Furthermore, there exists a long-felt need in the art for a garment electronic display system that can be used to advertise at a sporting event. More specifically, there exists a long-felt need in the art for a garment electronic display system that can be used to advertise at a sporting event wherein the system does not require a user to be in a stadium/arena or looking at a stadium/arena advertisement. In addition, there exists a long-felt need in the art for a garment electronic display system that can be used to advertise at a sporting event wherein the system does not require a user to be in a stadium/arena or looking at a stadium/arena advertisement while advertising in an innovative and creative manner.

The present invention, in one exemplary embodiment, is comprised of a garment electronic display system. The display screen can be controlled by a software/mobile application that allows custom advertisements, messages, etc., to be played on the screen. The garment of the system may include, but is not limited to, a jersey, a shirt, a jacket, a coat, a pair of pants, a pair of shorts, a hat, a top, a bottom, a pair of shoes, etc. At least one display screen is fixedly or removably attached to the garment via at least one fastener. The display screen is preferably a flexible electronic display screen to allow the screen to bend/move as the garment moves to prevent cracking/damage of the screen.

The display screen is also comprised of at least one receiver which places the screen in wireless electrical communication with the software of the system. The software may be in the form of a computer software program, a mobile application, etc. The software allows a user to relay various pictures, videos, words, letters, phrases, advertisements, etc., to the screen such that they are displayed on the screen.

The software may also allow a user to select at least one condition that when present relays a specific picture, video, word, letter, phrase, advertisement, sound, etc., to the display screen such that it is played. The condition may include, but is not limited to, a touchdown, a goal, a made basket, a scored point, a win, a loss, a tie, a play, a conversion, a homerun, a steal, a walk, a strikeout, an ejection, an official's call, etc., wherein the picture, video, word, letter, phrase, advertisement, noise, etc., may relate to said condition. In this manner, the screen automatically displays specific content when a specific event occurs during a live sporting event.

The present invention is also comprised of a method of using the device. First, a device is provided comprised of a garment comprised of at least one display screen, wherein the display screen is in wireless electrical communication with a software. Then, a user can wear the garment. Then, a user can attach the screen to the garment via a fastener. Next, the user can attend a sporting event while wearing the garment. Then, a piece of content such as, but not limited to, pictures, videos, words, letters, phrases, advertisements, sounds, etc., is played on the display screen and/or a speaker of the screen, in response to a condition present at the sporting event. Said condition may include, but is not limited to, a touchdown, a goal, a made basket, a scored point, a win, a loss, a tie, a play, a conversion, a homerun, a steal, a walk, a strikeout, an ejection, an official's call, etc.

The present invention is also comprised of a second method of using the device. First, a device is provided comprised of a garment comprised of at least one display screen, wherein the display screen is in wireless electrical communication with a software. Then, a user can wear the garment. Next, the user can attend a sporting event while wearing the garment. Then, a piece of content such as, but not limited to, pictures, videos, words, letters, phrases, advertisements, sounds, etc., is played on the display screen and/or a speaker of the screen. Next, a user can program a second piece of content to play on the screen and/or speaker in sequence with the first piece of content.

Accordingly, the garment electronic display system of the present invention is particularly advantageous as it provides an advertising system that can be used to advertise at a sporting event. Further, while doing so the system does not require a user to be in a stadium/arena or looking at a stadium/arena advertisement. Further, the system can be used to increase the experience of fans by providing interactive content shown on the display screen in relation to in-game events. In this manner, the garment electronic display system overcomes the limitations of existing advertising methods and devices known in the art.

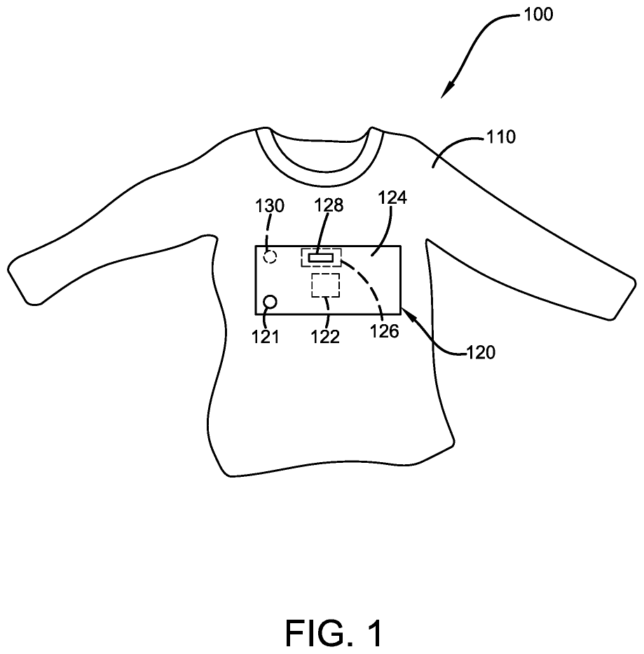

Referring initially to the drawings, FIG. 1 illustrates a perspective view of a garment 110 and a display screen 120 of one potential embodiment of a garment electronic display system of the present invention in accordance with the disclosed architecture. The system 100 is comprised of at least one garment 110 with at least one display screen 120 attached to the garment 110. The display screen 120 can be controlled by a software/mobile application 140 that allows custom advertisements, messages, etc., to be played on the screen 120.

The system 100 is comprised of at least one garment 110. The garment 110 may include, but is not limited to, a jersey, a shirt, a jacket, a coat, a pair of pants, a pair of shorts, a hat, a top, a bottom, a pair of shoes, etc. At least one display screen 120 is fixedly or removably attached to the garment 110 via at least one fastener 122. The fastener 122 may include, but is not limited to, a snap button, adhesive, iron-on, magnet, hook and loop, etc.

The display screen 120 may be any type of electronic display screen known in the art. In the preferred embodiment, the screen 120 is flexible to allow the screen 120 to bend/move as the garment 110 moves to prevent cracking/damage of the screen 120. In one embodiment, the screen 120 may be comprised of a transparent glass, plastic, or film protective layer 124. This layer 124 protects the screen 120 against cracking/chipping.

The screen 120 is powered by at least one battery 126. The battery 126 may be removable or disposable in different embodiments. The battery 126 may also be rechargeable or disposable in different embodiments. In a rechargeable embodiment, the device 100 may be comprised of at least one charging port 128, such as, but not limited to, a USB port, that allows a user to charge the battery 126.

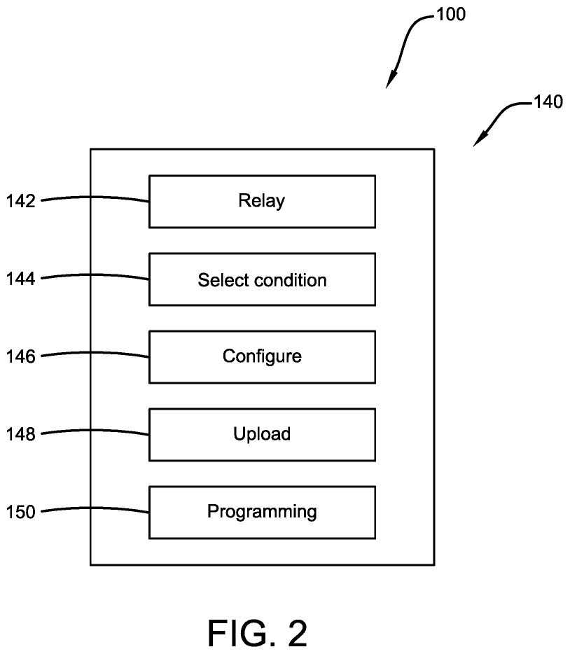

The display screen 120 is also comprised of at least one receiver 130. The receiver 130 places the screen 120 in wireless electrical communication with software 140 of the system 100. The software 140 may be in the form of a computer software program, a mobile application, etc. As seen in FIG. 2, the software 140 allows a user to relay 142 various pictures, videos, words, letters, phrases, advertisements, etc., to the screen 120 such that they are displayed on the screen 120. In one embodiment, the screen 120 can also or alternatively play a sound, a song, or a noise effect, via at least one speaker 121 of the screen 120.

The software 140 may also allow a user to select at least one condition 144 that when present relays a specific picture, video, word, letter, phrase, advertisement, sound, etc., to the display screen 120 such that it is played. The condition may include, but is not limited to, a touchdown, a goal, a made basket, a scored point, a win, a loss, a tic, a play, a conversion, a homerun, a steal, a walk, a strikeout, an ejection, an official's call, etc., wherein the picture, video, word, letter, phrase, advertisement, noise, etc., may relate to said condition. In this manner, the screen 120 automatically displays specific content when a specific event occurs during a live sporting event.

However, it should be noted that the system 100 can be used at any type of event, wherein content can be displayed on the screen 120 due to any condition at said event. In one embodiment, no event or condition is needed and content may be selected and displayed by a user on the screen 120 continuously, intermittently, etc., as selected by the programming feature 150.

In one embodiment, a user can configure 146 the software 140 such that their own custom conditions are used to determine what pictures, videos, words, letters, phrases, advertisements, sounds, etc., are shown/played on the display screen 120, wherein a user can also upload their own pictures, videos, words, letters, phrases, advertisements, sounds, etc., to the software 140. A programming feature 150 of the software 140 allows administrative users to program various sequences of advertisements and other content, which may or may not be based on specific conditions at a sporting event.

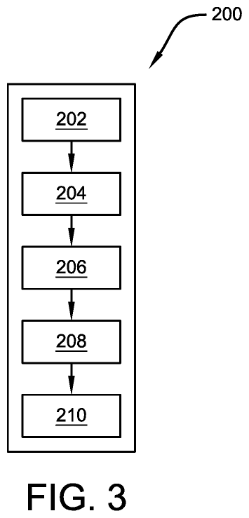

The present invention is also comprised of a method of using 200 the device 100, as seen in FIG. 3. First, a device 100 is provided comprised of a garment 110 comprised of at least one display screen 120, wherein the display screen 120 is in wireless electrical communication with a software 140 [Step 202]. Then, a user can wear the garment 110 [Step 204]. Then, a user can attach the screen 120 to the garment via a fastener 122 [Step 206]. Next, the user can attend a sporting event while wearing the garment [Step 208]. Then, a piece of content such as, but not limited to, pictures, videos, words, letters, phrases, advertisements, sounds, etc., is played on the display screen 120 and/or a speaker 121 of the screen 120, in response to a condition present at the sporting event [Step 210]. Said condition may include, but is not limited to, a touchdown, a goal, a made basket, a scored point, a win, a loss, a tie, a play, a conversion, a homerun, a steal, a walk, a strikeout, an ejection, an official's call, etc.

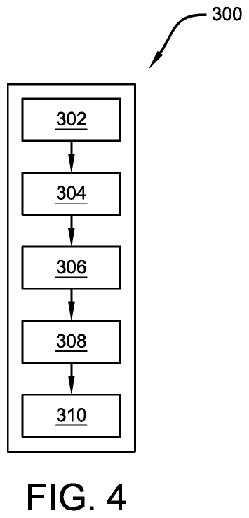

The present invention is also comprised of a second method of using 300 the device 100, as seen in FIG. 4. First, a device 100 is provided comprised of a garment 110 comprised of at least one display screen 120, wherein the display screen 120 is in wireless electrical communication with a software 140 [Step 302]. Then, a user can wear the garment 110 [Step 304]. Next, the user can attend a sporting event while wearing the garment [Step 306]. Then, a piece of content such as, but not limited to, pictures, videos, words, letters, phrases, advertisements, sounds, etc., is played on the display screen 120 and/or a speaker 121 of the screen 120 [Step 308]. Next, a user can program a second piece of content to play on the screen 120 and/or speaker 121 in sequence with the first piece of content [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “garment electronic display system” and “system” are interchangeable and refer to the garment electronic display system 100 of the present invention.

Notwithstanding the foregoing, the garment electronic display system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the garment electronic display system 100 as shown in the FIGS. are for illustrative purposes only, and that many other sizes and shapes of the garment electronic display system 100 are well within the scope of the present disclosure. Although the dimensions of the garment electronic display system 100 are important design parameters for user convenience, the garment electronic display system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A garment electronic display system comprising:
a garment;
a display screen comprised of a battery, a fastener, and a receiver; and
a software that relays a piece of content to the display screen.

2. The garment electronic display system of claim 1, wherein the display screen attaches to the garment via the fastener.

3. The garment electronic display system of claim 2, wherein the fastener is comprised of a snap button, an adhesive, an iron-on, a magnet, or a hook and loop.

4. The garment electronic display system of claim 1, wherein the garment is comprised of a jersey, a shirt, a jacket, a coat, a pair of pants, a pair of shorts, a hat, a top, a bottom, or a pair of shoes.

5. The garment electronic display system of claim 1, wherein the piece of content is comprised of a picture, a video, a word, a letter, a phrase, an advertisement, a sound, a song, or a noise effect.

6. The garment electronic display system of claim 1, wherein the display screen is comprised of an electronic display screen.

7. The garment electronic display system of claim 6, wherein the electronic display screen is comprised of a flexible electronic display screen.

8. The garment electronic display system of claim 1, wherein the display screen is comprised of a protective layer.

9. A garment electronic display system comprising:
a garment;
a display screen attached to the garment, the display screen comprised of a battery, a charging port, a fastener, and a receiver; and
a software that relays a piece of content to the display screen.

10. The garment electronic display system of claim 9, wherein the garment is comprised of a jersey, a shirt, a jacket, a coat, a pair of pants, a pair of shorts, a hat, a top, a bottom, or a pair of shoes.

11. The garment electronic display system of claim 9, wherein the piece of content is comprised of a picture, a video, a word, a letter, a phrase, an advertisement, a sound, a song, or a noise effect.

12. The garment electronic display system of claim 9, wherein the display screen is comprised of an electronic display screen.

13. The garment electronic display system of claim 12, wherein the electronic display screen is comprised of a flexible electronic display screen.

14. The garment electronic display system of claim 9, wherein the display screen is comprised of a protective layer.

15. The garment electronic display system of claim 9, wherein the battery is comprised of a removable battery.

16. The garment electronic display system of claim 9, wherein the battery is comprised of a rechargeable battery.

17. The garment electronic display system of claim 16, wherein the rechargeable battery can be recharged by the charging port.

18. A method of using a garment electronic display system, the method comprising the following steps:
providing a garment electronic display system comprised of a garment comprised of a display screen, wherein the display screen is in wireless electrical communication with a software;
attaching the display screen to the garment via a fastener; and
wearing the garment while attending a sporting event.

19. The method of using a garment electronic display system of claim 18, wherein a piece of content is played on the display screen when a condition is present at the sporting event.

20. The method of using a garment electronic display system of claim 18, wherein the condition is comprised of a touchdown, a goal, a made basket, a scored point, a win, a loss, a tie, a play, a conversion, a homerun, a steal, a walk, a strikeout, an ejection, or an official's call.
